(19) United States
(12) Patent Application Publication
(10) Pub. No.: US 2022/0324245 A1
(43) Pub. Date: Oct. 13, 2022

(54) PRINTING METHOD

(71) Applicant: XEIKON MANUFACTURING N.V., Lier (BE)

(72) Inventors: Wouter Jeroom Maria VAN GAENS, DUFFEL (BE); Werner Jozef Johan OP DE BEECK, PUTTE (BE); Lode Erik Dries DEPREZ, LIER (BE); Roel DE MONDT, RUMST (BE)

(73) Assignee: XEIKON MANUFACTURING N.V., Lier (BE)

(21) Appl. No.: 17/639,541

(22) PCT Filed: Sep. 3, 2020
(86) PCT No.: PCT/EP2020/074634

§ 371 Date: Mar. 1, 2022

(30) Foreign Application Priority Data
Sep. 3, 2019 (NL) 2023752

(51) Int. Cl. B41M 5/00; B41J 2/21; B41M 7/00; B41M 5/52

(52) U.S. Cl. CPC B41M 5/0017; B41J 2/21; B41M 7/009; B41M 5/5218; B41M 5/5245

(57) ABSTRACT

A printing method in which a primer composition, which includes at least one pigment aggregating agent, is applied to a coated substrate prior to an ink-jet printing step. The ink-jet printing step is performed using inkjet droplets having x μm drop diameter, printed in a print resolution on the coated substrate that corresponds to a rectangular unit cell having cell dimensions of y μm by z μm, where a ratio of x/y is >0.60.

### FIELD OF INVENTION

The field of the invention relates to a printing method.

### BACKGROUND

In ink-jet printing methods, droplets of ink are directly projected onto a printing substrate from very fine nozzles and allowed to adhere to the printing substrate to obtain printed materials on which characters or images are printed. The ink-jet printing methods have now been extensively employed not only in printing applications for ordinary consumers but also recently in commercial and industrial printing applications because of various advantages such as easiness of full coloration, low cost, variability, capability of using a plain paper as the printing medium, non-contact with printed characters or images, etc.

The ink droplets may be printed using pigmented aqueous inks. In general more than one type of colored pigmented aqueous ink, such as cyan, magenta, yellow and black, is used to print a multi-color image. The color may be formed by printing one, two or more different colored pigmented aqueous inks on the same printing location of the substrate.

Some commercial and industrial ink-jet printers utilize fixed printheads and a moving substrate, such as a web, in order to achieve high speed printing. This is also referred to as single pass printing as the substrate is only transported once along the fixed printheads while the full color image is formed onto the substrate.

Corrugated board is a material that includes at least one fluted corrugated sheet and one or two flat liners covering that corrugated sheet. Several of those packages can be combined in one stack to create one corrugated board. It is made on flute lamination machines or corrugators and is used in the manufacturing of displays, (art) objects, shipping containers and corrugated boxes. Corrugated boxes are used for the shipping of a variety of items due to their strength, durability, lightness, recyclability, and cost-effectiveness. Corrugated boxes, used as shipping containers may require printing and labels to identify the contents, to provide legal and regulatory information, and to provide bar codes for routing. Packaging boxes and other objects made of corrugated materials that are used for marketing, merchandising, and point-of-sale often have high graphics to help communicate the contents or a message related to the content or the brand.

When printing the pigmented aqueous inks on coated substrates, the absorption of the ink droplets by the coated substrates may be slow. Many coated substrates usable as liners of corrugated boards are prepared to provide durability (e.g. water fastness), gloss, a luxurious look to the corrugated boards and are not adapted to absorb pigmented aqueous inks. When the ink droplets remain for a longer time on the surface of the coated substrate the ink will have a slower drying time and this may lead to image defects, such as coalescence or inter-color bleeding.

Typically primers are used in (ink-jet) printing to enhance the color strength (optical density), adhesion and/or image sharpness of ink-jet inks on quick absorbing (uncoated) substrate materials. One type of primer contains polyvalent metal salts or acidic compounds. Its working mechanism is mainly based on the destabilization and agglomeration of pigment particles. The pigment agglomerates penetrate less deeply in the paper pores, which results in enhanced optical density, color strength and reduced transparency. Bleeding/mottle is usually no issue with these type of substrates as the ink liquid medium still penetrates the paper easily and the color image is fixed almost instantaneously.

For coated substrates with low porosity such a primer is not expected to be useful as pigments from the ink-jet inks are already kept at the surface on the coated substrate rather than being lost in depth of the pores. Moreover, when printing on various coated substrates, it has been found that non-uniform color layers may be formed, wherein white stripes occur in in area's having a lower amount of ink drops, and at the same time inter-color bleeding may occur in area's having higher amount of ink drops. The primer composition is known to inhibit or decrease spreading of ink drops on the substrates. This effect on ink spreading is in contradiction with solving both problems including the white stripes.

A second type of primer uses a binder that seals off the pores of the absorbing substrate materials. By closing the pores, pigments from the ink-jet inks are kept at the surface rather than being lost in depth of the paper (board), the latter would cause loss of color strength. However, due to the loss of porosity ink particles can move freely over the substrate which can result in dewetting effects or on the other hand severe bleeding, feathering and/or mottle formation, edge effects with increased color density. Moreover, a significant amount of binder is required to close off the pores significantly which contributes to the total cost of the image forming process. Finally, the binder layer alters the gloss of the substrate which is most of the time undesirable.

A third type of primer or pre-coat for substrate papers (such as corrugated boards) uses porous inorganic particles (e.g. silica), with a high specific surface area, typically embedded in a polymer matrix (cf. second type of primer as mentioned above). This paper pre-coat with usage of porous inorganic particles with controlled pore size and even distribution across the paper surface, allows for the creation of sharp images, with reduced ink bleeding and increased color strength (optical density). The disadvantage of this technique is the high complexity and cost of such a coating. To have a functional amount of void space to absorb the ink liquid, the wet coating layers are very thick and if applied inline they need to be fully dried which demands a very high drying capacity, especially for high speed printing processes. Furthermore, it is very difficult to find a balance between binder content and pigment concentration in this type of coatings to achieve high capillarity but still sufficient adhesion to the substrate and avoid dusting effects.

Application of these known primer types to several coated substrates having slow absorption has been found to yield insufficient effect on the image quality.

Selecting a suitable coated substrate and/or adapting the coating of the coated substrate is often used for solving the image defects, however, this approach is very time-consuming, very expensive and not versatile. Other solutions that have been tried to fix the issue of inter-color bleeding use software-based image adjustments (U.S. Pat. No. 6,361,144).

Taking all of these observations into account, a desire exists to provide a printing method using ink-jet printing on coated substrates, especially slowly absorbing coated substrates, wherein a good image quality is obtained.

### SUMMARY

According to a first aspect of the invention there is provided a printing method, wherein a primer composition, which comprises at least one pigment aggregating agent, is applied to a coated substrate prior to an inkjet printing step, wherein the ink-jet printing step is performed using ink droplets having x μm drop diameter, printed in a print resolution on the coated substrate that corresponds to a rectangular unit cell having cell dimensions of y μm by z μm, wherein the ratio of x/y is >0.60.

Surprisingly, it has been found that by first applying a primer composition on the coated substrate and selecting a ratio of x/y higher than 0.60 for the ink droplets for the inkjet printing step solves both image defects at the same time: white stripes in areas having a lower amount of ink drops and inter-color bleeding in areas having higher amount of ink drops. As applying a primer composition to the coated substrate is known to decrease spreading of ink drops on the substrates, solving both problems at the same time was not expected. The drop diameter x μm may be increased and/or the cell dimension y may be decreased to result in the ratio of x/y higher than 0.60.

The ink-jet printing step is performed by applying the ink droplets at a print resolution on the coated substrate that corresponds to a unit cell, which is rectangular. The unit cell has cell dimensions of y μm by z μm, wherein the y dimension corresponds to a print resolution of the ink droplets in a first direction and the z dimension corresponds to a print resolution of the ink droplets in a second direction. The y dimension and the z dimension are arranged perpendicular to one another, wherein the unit cell has a rectangular form, preferably a square form.

A unit cell according to the invention is schematically illustrated in FIG. 3. FIG. 3 shows a unit cell 2, which is rectangular. The unit cell has a y dimension along a first direction A on the surface of the substrate and has a z dimension along a second direction B on the surface of the substrate.

The y dimension and the z dimension may be substantially equal to one another or may differ in length.

In inkjet printing, the unit cell 2 is repeated on the surface of the substrate in other unit cells 2′ both along the first direction A and the second direction B. Although in FIG. 3 only three other unit cells 2′ are illustrated, the number of other unit cells 2′ is not restricted. Typically, the other unit cells 2′ may extend over the whole printing area of the substrate. The other unit cells 2′ have the same dimensions, y in the first direction A and z in the second direction B, respectively, as the unit cell 2.

The unit cell y dimension may be selected in any suitable direction on the substrate. In particular, the unit cell y dimension may be selected perpendicular to a substrate transport direction, which is the transport direction of the substrate during ink jet printing step.

In particular, it has been found in high speed printing using single pass ink-jet printing, that selecting the print resolution in the direction perpendicular to a substrate transport direction may be most relevant for solving the problem of white streaks and bleeding at the same time. In this example, the y dimension is selected perpendicular to a substrate transport direction.

The unit cell z dimension of the unit cell may be any suitable distance (in μm). Preferably, the ratio between the y dimension and the z dimension is between 1:2 and 2:1. The z dimension may be suitably selected such that one inkjet droplet may be placed on the coated substrate in the unit cell to substantially fill the area of the unit cell on the coated substrate.

The droplets have x μm drop diameter. The drop diameter may be determined as an average drop diameter over a number of droplets. The drop diameter according to the invention may be calculated by gravimetrically determining an average weight of an ink droplet by collecting a number of ink droplets, and using a known density of the ink of the ink droplets to calculate the drop diameter by assuming an ideal spherical shape of the ink droplets. The number of ink droplets to be collected is determined by jetting frequency and jetting period. The ink droplet size may be controlled by print head settings, such as the waveform and the jetting frequency.

In a particular embodiment, the ratio of x/y is >0.70. It has been found that the ratio x/y higher than 0.70 may further improve lower the stripes level without any bleeding even for coated substrates having low absorption rate for the ink.

In a particular embodiment, the ratio of x/y is >0.90. It has been found that the ratio x/y higher than 0.90 may further improve lower the stripes level without any bleeding even for inks having a relatively low static contact angle on the coated substrate.

In an embodiment, the ratio of x/y is >0.60 and <2.0. Preferably, the ratio of x/y is <1.5. Even more preferably, the ratio of x/y is <1.0.

The primer composition comprises at least one pigment aggregating agent. The pigment aggregating agent is not particularly limited insofar as the pigment contained in the ink-jet ink can be aggregated.

In an embodiment, the at least one pigment aggregating agent is selected from the group consisting of an ionic polymer, a multivalent metal salt, an acid, and mixtures thereof. Primer compositions comprising pigment aggregating agent are known from the prior art and may be used as primer composition according to the present invention. In examples, the ionic polymer may be an anionic polymer and may be a cationic polymer. In examples, the acid may be an organic acid and may be an inorganic acid.

Only one type of the pigment aggregating agent may be used in the primer composition, or two or more types thereof may be used. Examples of the multivalent metal salt include calcium chloride, magnesium nitrate, and aluminum chloride. Examples of the acid include a malonic acid, a malic acid, a citric acid, a phosphoric acid, and a succinic acid.

The primer composition may be applied in any suitable way onto the coated substrate. The primer composition may be applied using techniques to completely cover the coated substrate with a uniform layer of primer composition and may be applied using digital printing techniques, such as ink-jet printing to apply it image wise.

The primer composition may be a water-based primer composition, wherein a suitable amount of water including optional co-solvents is used as carrier liquid for the at least one pigment aggregating agent. The at least one pigment aggregating agent may be dissolved, emulsified or dispersed in the water-based primer composition.

The primer composition on the coated substrate may be thermal treated after applying on the coated substrate to at least partially or fully dry the primer composition before applying the ink droplets. Alternatively, the ink droplets may be printed without actively thermal drying of the primer composition on the coated substrate. It has been found that not actively drying of the primer composition on the coated substrate may have advantages in a better restriction of the bleeding of the ink on the coated substrates.

The primer composition may be applied once before printing ink droplets of several colored inks on the coated substrates, such as applied once before printing ink droplets of cyan, magenta, yellow and black ink on the coated substrates. Alternatively, the primer composition may be applied to the coated substrate any time before printing ink-jet droplets of a respective colored ink on the coated substrates.

In an embodiment, the inkjet printing process uses pigmented aqueous inks Pigmented aqueous inks are mainly used to provide durable color images, such as for outdoor use. Pigmented aqueous inks may be dried by active thermal heating of the coated substrate before, after or during the printing. The pigmented aqueous inks may have the disadvantage of a slow absorption by coated substrates.

In an embodiment, the coated substrate has an absorption rate defined by a drop travel distance larger than 10.0 cm, preferably between 10.0 cm and 25.0 cm, more preferably between 12.0 cm and 20.0 cm, wherein the drop travel distance is defined by the distance travelled by a 2 ml drop of a reference liquid at 50 seconds after being placed on the substrate and wherein the substrate is placed under an angle of 60° with respect to a horizontal plane. The coated substrates having a drop travel distance larger than 10.0 cm have a slow absorption rate. The reference liquid composition resembles an ink without pigments and is very low viscous. The absorption rate test according to the invention and its testing conditions are further explained in the detailed description.

The coated substrates may have such a slow absorption rate due to a low porosity of the surface of the coated substrate and/or due to a high hydrophobicity of the coated substrate. The slow absorption rate may allow the ink droplets to further spread on the surface leading to inter-color bleeding. Another disadvantage due to the lower absorption rate is increased drying time of an ink.

In an embodiment, the ink of the inkjet droplets has a static contact angle on the coated substrate lower than 26°, preferably lower than 23°, more preferably lower than 20°, in particular between 26° and 2°, more preferably not lower than 5°. A lower static contact angle of the ink on the coated substrate is correlated with an improved spreading of the ink on the coated substrate and with a lower level of white stripes in low ink density areas.

In an embodiment, the ink of the inkjet droplets has a static contact angle on various coated substrates lower than 26°, preferably lower than 23°, more preferably lower than 20°. The various coated substrates may differ in absorption rate and/or static contact angle of the ink. When the ink has the lower static contact angle of the ink on the various coated substrate, a good image quality can be obtained with the same ink on each of the coated substrates. The static contact angle on each of the various coated substrates is not lower than 2°, more preferably not lower than 5°. Even when the static contact angle of the ink is very low, close to the lower limit, the bleeding can be solved by the printing method of the invention.

In an embodiment, the ink of the ink-jet droplets has a static surface tension lower than 32 mN/m, preferably between 30 and 18 mN/m. The static surface tension is preferably between 30 and 18 mN/m. Surfactants and/or humectants may be selected to decrease the static surface tension.

In an embodiment, a random co-polymer is used as the dispersing agent for the stabilization of the pigments in the pigment dispersion.

In an embodiment, a graft co-polymer is used to disperse the pigment particles and create the pigment dispersion.

In an embodiment, the pigments used in the inkjet inks are dispersed using encapsulated dispersion technology. Known methods can be used for dispersing the pigment and consecutively the achieved dispersion is further treated wherein the resin is crosslinked around the pigment surface thereby encapsulating the pigment. Examples from patent literature by Fujifilm Imaging Colorants, Kao, DuPont, Riso Kagaku, Xerox and Seiko Epson are given in the detailed description.

In an embodiment, the pigments used in the ink-jet are dispersed using a block co-polymer dispersant. The properties of polymeric dispersants depend on both the nature of the monomers and their distribution in the polymer. Improvements in dispersion stability are obtained using block co-polymer dispersants. Block co-polymer dispersants may contain hydrophobic and hydrophilic blocks.

In an embodiment, a ratio z/y is between 0.5 and 2.0, wherein z is arranged orthogonal to y. This ratio, wherein the unit cell z dimension and the y dimension are substantially similar to one another, is preferred to obtain a suitable filling of the unit cell area by a inkjet droplet.

In a particular embodiment, the ratio z/y is between 0.6 and 1.5, more preferably between 0.8 and 1.2, even more preferably the ratio z/y is between 0.9 and 1.1.

In an embodiment, the coated substrate is a liner suitable to produce corrugated boards. The coated substrate may be assembled with a corrugated sheet to form the corrugated board before or after performing the printing method to form an image on the coated substrate. The corrugated board may have one coated substrate at one side of the corrugated sheet or two coated liners adhered to the corrugated sheet, with the corrugated sheet arranged in between them.

In an embodiment the printing method is performed on a coated liner that is not attached to a fluted liner (being a corrugated sheet or another corrugated medium). This coated liner can be a sheet or a roll (web) and is then further used to produce corrugated board. The printing method used is often referred to as pre-print methodology.

In an embodiment, the ink droplets are printed onto the liner surface after producing the corrugated board. This has the advantage that the corrugated board is already produced and no damage may occur to the printed image due to manufacturing steps of produce corrugated boards.

In an embodiment, a jetting distance of the ink droplets is >2 mm. A jetting distance larger than 2 mm is suitable to print on coated substrates which have already been used to be assembled in a larger product, such as corrugated boards, and are not very flat during transport of the coated substrate along the inkjet printheads. It has been found that when the jetting distance of the ink droplets is >2 mm the problem of white streaks and bleeding may occur more often or may occur on more coated substrates. The printing method according to the present invention may solve the problem even for a jetting distance of the ink droplets is >2 mm.

In an embodiment, the ink-jet printing step is carried out at a substrate transport velocity of at least 0.5 m/s. This substrate transport velocity is in particular suitable to print on a substrate in a single pass printing process, wherein the substrate passes the print head stations once to form the image on the substrate. The substrate may be transported using a belt, a web or any other transport means. In an embodiment, the ink-jet printing step is followed by a thermal drying step. The thermal drying step may ensure that the coated substrate and the ink on the coated substrate are dry before further handling the coated substrate and/or before ink-jet printing ink droplets of an additional ink color onto the coated substrate.

In an embodiment, the ink-jet printing method uses piezo-operated printheads. The piezo-operated printheads are preferred for their durability, their control on ink droplet size (gray-scale capability) and their flexibility to print various inks, such as inks having a higher viscosity. Print head technologies are known to be used in corrugated printing. It should be noted that UV-inkjet is only used in combination with piezoelectric printheads, since thermal printheads cannot deal with the reactive monomers present in UV-inks. In this embodiment the method uses drop-on-demand (DOD) piezo heads for water-based inks Thermal heads may be less preferred due to the lack of grayscale printing (different drop sizes depending on the waveform, as available in piezo printheads), the issues of kogation, lower lifetimes and the low commercial availability in industrial printing quality (small office and home office printing uses mostly thermal heads, but not of industrial quality). Furthermore, commercially available industrial thermal heads are available from Memjet, however wherein the use of pigmented inks is still limited. For piezo DOD print heads there is a huge amount of variation present in the field: MEMS based, bulk piezo, resolution, (non) through-flow technology, variations in waveforms, digital or binary, variations in jetting frequency. There is no limitation to the piezo sub categories in this embodiment of the invention. FujiFilm, Konica Minolta, Xaar, Kyocera, Xerox, Seiko, Ricoh are all manufacturers that offer this type of printheads.

In an embodiment, the inkjet printing step comprises printing at least 4 ink-jet printing colors comprising cyan, magenta, yellow and black.

In an embodiment, the method comprises a thermal drying step of the coated substrate before, during or after the printing of the ink droplets on the coated substrate. This is preferred in case the drying time of the ink is slow, such as when the ink has a slow absorption rate on the substrate.

### BRIEF DESCRIPTION OF THE FIGURES

The accompanying drawings are used to illustrate presently preferred non-limiting exemplary embodiments of devices of the present invention. The above and other advantages of the features and objects of the invention will become more apparent and the invention will be better understood from the following detailed description when read in conjunction with the accompanying drawings, in which:

FIG. 1 illustrates schematically a test chart to test image quality;

FIG. 2A-2E illustrate schematically embodiments of a printing system for carrying out the printing method according to the present invention;

FIG. 3 illustrates schematically a unit cell according to the present invention.

### DETAILED DESCRIPTION

As used herein, the term “dispersion” means a two-phase system wherein one phase consists of finely divided particles (often in a colloidal size range) distributed throughout a bulk substance, the particles being the dispersed or internal phase and the bulk substance being the continuous or external phase.

As used herein, the term “dispersant” means a surface active agent added to a suspending medium to promote uniform and maximum separation of extremely fine solid particles often of colloidal sizes. For pigments, the dispersants are most often polymeric dispersants, and the dispersants and pigments are usually combined using a dispersing equipment.

As used herein, the term “aqueous” refers to water or a mixture of water and at least one water-soluble, or partially water-soluble, organic solvent (co-solvent).

As used herein, the term “water-based primer composition” refers to a primer composition having a water carrier or a carrier of mixture of water and at least one water-soluble, or partially water-soluble, organic solvent (co-solvent, humectant and/or penetrant).

As used herein, the term “substantially” means being of considerable degree, almost all.

The materials, methods, and examples herein are illustrative only except as explicitly stated, and are not intended to be limiting.

Primer Composition

The pigment aggregating agent is not particularly limited insofar as the pigment contained in the ink-jet ink can be aggregated. Some suitable pigment aggregating agents include ionic polymers and co-polymers, such as anionic polymers, anionic co-polymers, cationic polymers and cationic co-polymers, multivalent metal salts, and acids, such as organic acids and inorganic acids. Only one type of the pigment aggregating agent may be used, or two or more types thereof may be combined.

A method for characterizing the pigment aggregating agent, is by adding a pigment containing droplet into a primer containing test tube, thereby settling/aggregating/coagulating instead of spreading throughout the rest of the liquid by Brownian motion (seemingly dissolving).

The cationic polymers and co-polymers in the primer composition attract and fix oppositely charged anionic pigment dispersion and anionic binder molecules to the substrates. Such cationic resins may incorporate charge groups in the main polymer backbones, or as side groups in the polymer chains, generally containing quaternary ammonium groups so that the formal positive charge is present irrespective of the pH level. Cationic polymers have also been synthesized which contain quaternary ammonium, sulphonium or phosphonium groups. Weak electrolyte versions are in use which acquire cationic properties in acidic media and are based on polyamines containing primary, secondary or tertiary amino groups, or mixtures of them. The preparative techniques cover polymerizations by chain growth and step growth mechanisms, often in simple aqueous solutions, but also as water-in-oil emulsions, and the modification of existing polymers.

The cationic polymers for use in the primer coating may include, but are not limited to, polymers and co-polymers of diallyldialkyammonium monomers such as diallyldimethylammonium chloride, such as polydiallyldimethyl-ammonium chloride (PDADMAC); polymer and co-polymers of cationic acrylate and acrylamide such as polyacryloxyethyldimethylammonium chloride or polyacrylamidoethyldimethylammonium chloride; polymers and co-polymers of quartemized vinylpyridine such as polymethyl vinylpyridine chloride; polyalkylamine and quaternary ammonium polymers and co-polymers; linear and branched polyethyleneimine; polyvinylamine; and polymers and co-polymer derived from epichlorohydrin such as epihalohydrin-amine polymers,

“Multivalent” indicates an oxidation state of two or more and, for an element “Z”, are typically described as Z²⁺, Z³⁺, Z⁴⁺ and so forth. For brevity, multivalent cations may be referred to herein as Z^{x}. The multivalent cations are substantially soluble in the aqueous primer solution and preferably exist (in solution) in a substantially ionized state.

Z^{x} includes at least one, but is not limited to multivalent cations of the following elements: Mg, Ca, Sr, Ba, Sc, Y, La, Ti, Zr, V, Cr, Mn, Fe, Ru, Co, Rh, Ni, Pd, Pt, Cu, Au, Zn, Al, Ga, In, Sb, Bi, Ge, Sn, Pb. Preferably the multivalent cation is calcium. The primer composition is preferably based on what is acceptable on regulatory and toxicological guidelines.

Z^{x} can be incorporated into primer solution by addition in a salt form or by addition in an alkaline form and used as a base in the adjustment of the primer solution pH.

The associated anionic material can be chosen from any common anionic material, especially halides, nitrates and sulfates. The anionic form is chosen so that the multivalent cation is soluble in the aqueous primer solution. The multivalent cationic salts can be used in their hydrated form. One or more multivalent cationic salts may be used in the primer solution. For calcium, the preferred multivalent cation salts are calcium chloride, calcium nitrate, calcium nitrate hydrate and mixtures thereof.

An acid as aggregating agent precipitates ink drops by lowering the inks' pH and coagulating pigment dispersion and other ink components. Specific examples of acids are polyacrylic acid, acetic acid, glycolic acid, malonic acid, maleic acid, ascorbic acid, succinic acid, glutaric acid, fumaric acid, citric acid, tartaric acid, lactic acid, phosphorous acid, sulfonic acid, orthophosphoric acid, pyrrolidone carboxylic acid, pyrone carboxylic acid, pyrrole carboxylic acid, furan carboxylic acid, pyridine carboxylic acid, coumaric acid, thiophene carboxylic acid, nicotinic acid and derivatives of these compounds. Polyacrylic acid, citric acid and acetic acid are particularly preferred.

Alternatively, when the dye is cationic or the pigment is primarily stabilized by cationic functionalities, the primer may be composed of an anionic aggregating agent. This anionic aggregating agent may be an inorganic base or polymer with anionic functionalities. Examples of anionic aggregating agents are Zetag 4145 (BASF), Magnafloc LT30 (BASF), SETAQUA® 6407 (Allnex). The primer composition may also contain colorants, organic solvents, humectants, binders, surfactants, biocides, corrosion inhibitors, viscosity adjusting agents and other components as described below for the inkjet inks.

Also commercial primer compositions can be used as long as they aggregate the pigment particles. Commercial primer are for example available as 171236PX from Michelmann, TP unicoat UCB and TP WB unicoat LC both from Siegwerk.

The viscosity of the primer solution is adjusted according to the application technique, but is preferably from 1 mPa·s to 200.0 mPa·s, and even more preferably from 3.0 mPa·s to 50 mPa·s, determined at RT.

Aqueous Inks

Aqueous inks can be broadly classified into pigment dispersion inks and dye inks. In recent years, demand has been growing for pigment dispersion inks, which exhibit excellent color development and solvent, gas and (UV-)light resistance and the like. On the other hand, in the case of pigment aqueous dispersion inks, because the pigment is insoluble in water, in many cases, satisfactory pigment dispersibility cannot be achieved. Accordingly, in order to maintain favorable pigment dispersibility within aqueous inks, pigment dispersing resins have been used to achieve better dispersion stability of the pigment in water. These pigments are also considered better performing towards migration into food.

The use of a colorant in inks as described above is the most essential form of a water-based ink. However in order to prevent drying of the ink at the nozzles, aqueous inks used in inkjet printing methods typically also contain a water-soluble solvent having a high boiling point and favorable solubility in water. This type of solvent is regarded as a humectant in the aqueous ink.

Further, to enable a minimal amount of wetting and spreading of water-based inks in the printhead, on the substrate, etc. the aqueous inks used in ink-jet printing methods typically also contain one or more surfactants.

Finally, the aqueous ink composition may also contain various types of additives such as anti-foaming agents, thickeners, binders and preservatives as required. Adding these types of additives to the aqueous ink composition enables the composition to be used more favorably as an ink-jet ink.

Colorant

Dye

The colorant in the ink can be a pigment, a dye, or a combination thereof. The colorant can be present in an amount from 0.5 wt % to 20 wt % in the ink.

The colorant can be a dye. The dye can be nonionic, cationic, anionic, or a mixture of nonionic, cationic, and/or anionic dyes. Specific examples of dyes that can be used include, but are not limited to, Sulforhodamine B, Acid Blue 113, Acid Blue 29, Acid Red 4, Rose Bengal, Acid Yellow 17, Acid Yellow 29, Acid Yellow 42, Acridine Yellow G, Acid Yellow 23, Acid Blue 9, Nitro Blue Tetrazolium Chloride Monohydrate or Nitro BT, Rhodamine 6G, Rhodamine 123, Rhodamine B, Rhodamine B Isocyanate, Safranine O, Azure B, and Azure B Eosinate, which are available from Sigma-Aldrich Chemical Company (St. Louis, Mo.). Examples of anionic, water-soluble dyes include, but are not limited to, Direct Yellow 132, Direct Blue 199, Magenta 377 (available from Ilford AG, Switzerland), alone or together with Acid Red 52. Examples of water-insoluble dyes include azo, xanthene, methine, polymethine, and anthraquinone dyes. Specific examples of water-insoluble dyes include Orasol® Blue GN, Orasol® Pink, and Orasol® Yellow dyes available from Ciba-Geigy Corp. Black dyes may include, but are not limited to, Direct Black 154, Direct Black 168, Fast Black 2, Direct Black 171, Direct Black 19, Acid Black 1, Acid Black 191, Mobay Black SP, and Acid Black 2.

Pigment

A pigment is preferably used from the viewpoints of offering excellent water resistance, light resistance, weather resistance and gas resistance or the like. Examples of pigments that may be used in the present invention include conventional organic pigments and inorganic pigments. The pigment may be chosen from those disclosed by HERBST, W, et al. Industrial Organic Pigments, Production, Properties, Applications. 2nd edition. vch, 1997.

The pigment particles in the pigmented ink-jet ink should be sufficiently small to permit free flow of the ink through the ink-jet printing device, especially at the ejecting nozzles. It is also desirable to use small particles for maximum color strength and to slow down sedimentation.

The average particle size of the pigment in the pigmented ink-jet ink should be between 0.005 μm and 15 μm. Preferably, the average pigment particle size is between 0.005 μm and 5 μm, more preferably between 0.005 μm and 1 μm, particularly preferably between 0.005 μm and 0.3 μm and most preferably between 0.040 μm and 0.150 μm. Larger pigment particle sizes may be used as long as the objectives of the present invention are achieved.

The pigment is used in the pigmented ink-jet ink in an amount of 0.1 to 20 wt %, preferably 1 to 10 wt % based on the total weight of the pigmented inkjet ink.

Examples of cyan pigments that can be used in the present invention include C.I. Pigment Blue 1, 2, 3, 15:3, 15:4, 15:6, 16 and 22, and C.I. Vat Blue 4 and 6. Among these, C.I. Pigment 15:3 and 15:4 are preferred. These cyan pigments may be used individually, or a combination of two or more pigments may be used.

Examples of magenta pigments that can be used in the present invention include C.I. Pigment Red 5, 7, 12, 22, 23, 31, 48 (Ca), 48 (Mn), 49, 52, 53, 57 (Ca), 57:1, 112 and 122; Quinacridone solid solutions 146, 147, 150, 185, 238, 242, 254, 255, 266 and 269, and C.I. Pigment Violet 19, 23, 29, 30, 37, 40, 43 and 50. Among these, the use of one or more pigments selected from the group consisting of C.I. Pigment Red 122, 150, 155, 185, 266 and 269, and C.I. Pigment Violet 19 is preferred.

Examples of yellow pigments that can be used in the present invention include C.I. Pigment Yellow 10, 11, 12, 13, 14, 17, 20, 24, 74, 83, 86, 93, 94, 95, 109, 110, 117, 120, 125, 128, 137, 138, 139, 147, 148, 150, 151, 154, 166, 168, 180, 185 and 213. Among these, the use of one or more pigments selected from the group consisting of C.I. Pigment Yellow 13, 14, 74, 150, 155 and 185 is preferred.

Examples of black pigments that can be used in the present invention include organic pigments such as aniline black, Lumogen black and azomethine black, and inorganic pigments such as carbon black and iron oxide. Further, a plurality of color pigments such as the aforementioned yellow pigments, magenta pigments and cyan pigments may be mixed together and used as a black pigment.

There are no particular limitations on the inorganic pigments that may be used in the present invention. Examples of inorganic pigments other than the carbon black and iron oxide mentioned above include titanium oxide.

Examples of carbon black pigments that can be used in the present invention include carbon blacks produced using the furnace method or the channel method.

Examples of commercial products are listed below, and any of these products can be used favorably.

Specific examples include No. 33, 40, 45, 52, 900, 2200B, 2300, MA7, MA8 and MCF88 (all manufactured by Mitsubishi Chemical Corporation), RAVEN 1255 (manufactured by Columbian Chemicals Co., Inc.), REGAL 330R, 400R and 660R, and MOGUL L (all manufactured by Cabot Corporation), and Nipex 1601Q, Nipex 1701Q, Nipex 75, Printex 85, Printex 95, Printex 90, Printex 35 and Printex U (all manufactured by Orion Engineered Carbons LLC).

In this embodiment of the present invention, the pigment is not limited to the pigments described above, and other special colors such as orange pigments and green pigments can also be used.

Further, a plurality of pigments may be combined. Moreover, in another embodiment, the aqueous ink composition of this embodiment of the present invention may be combined with a clear ink containing no pigment and used as an ink set.

Any other pigment and/or dye can be used that is useful in modifying the color of the ink. Additionally, the colorant can include a white pigment such as titanium dioxide, or other inorganic pigments such as zinc oxide and iron oxide.

Pigment Dispersing Resin

In order to enable the pigment described above to be used in the aqueous ink composition, the pigment must be able to be dispersed stably in water, and then held stably within the dispersion. Known methods can be used for dispersing the pigment. A first example include methods in which dispersion is achieved using a dispersing resin. The resin might be crosslinked around the pigment surface, thereby rendering an encapsulated pigment (EP2896666B1 (Riso Kagaku), EP1838427B1 (FFIC), EP3275949A1 (Kao), US20140011941A1 (DuPont) U.S. Pat. No. 9,267,044 (FFIC), (Seikon Epson), EP2252664B1 (Xerox)). A dispersing resin or dispersant is a substance for promoting the formation and stabilization of a dispersion of pigment particles in a dispersion medium. Dispersants are generally surface-active materials having an anionic, cationic or non-ionic structure. The presence of a dispersant substantially reduces the dispersing energy required. Dispersed pigment particles may have a tendency to re-agglomerate after the dispersing operation, due to mutual attraction forces. The use of dispersants also counteracts this re-agglomeration tendency of the pigment particles.

Polymeric dispersants contain in one part of the molecule so-called anchor groups, which adsorb onto the pigments to be dispersed. In a spatially separate part of the molecule, polymeric dispersants have a polymer chain which sticks out and whereby pigment particles are made compatible with the dispersion medium, i.e. stabilized.

Examples of the polymer dispersion agent include a block co-polymer, a random co-polymer, and salts thereof, and the like. The polymer dispersion agent may have a structure derived from two or more types of monomers styrene, a styrene derivative, a vinyl naphthalene derivative, an acrylic acid, an acrylic acid derivative, a maleic acid, a maleic acid derivative, an itaconic acid, an itaconic acid derivative, a fumaric acid, and a fumaric acid derivative. Only one type of the polymer dispersion agent may be used, or two or more types thereof may be used.

The properties of polymeric dispersants depend on both the nature of the monomers and their distribution in the polymer. Polymeric dispersants obtained by randomly polymerizing monomers (e.g. monomers A and B polymerized into ABBAABAB) or by polymerizing alternating monomers (e.g. monomers A and B polymerized into ABABABAB) generally result in a poor dispersion stability. Improvements in dispersion stability were obtained using graft copolymer and block co-polymer dispersants. Graft co-polymer dispersants consist of a polymeric backbone with side chains attached to the backbone. CA 2157361 (DU PONT) discloses pigment dispersions made by using a graft co-polymer dispersant with a hydrophobic polymeric backbone and hydrophilic side chains.

Other graft co-polymer dispersants are disclosed in U.S. Pat. No. 6,652,634 (LEXMARK), U.S. Pat. No. 6,521,715 (DU PONT) and US 2004102541 (LEXMARK).

Block co-polymer dispersants containing hydrophobic and hydrophilic blocks have been disclosed in numerous inkjet ink patents.

U.S. Pat. No. 5,859,113 (DU PONT) discloses an AB block copolymer dispersant with a polymeric A segment of polymerized glycidyl (meth)acrylate monomers reacted with an aromatic or aliphatic carboxylic acid, and a polymeric B segment of polymerized alkyl (meth)acrylate monomers having 1-12 carbon atoms in the alkyl group, hydroxy alkyl (meth)acrylate monomers.

U.S. Pat. No. 6,413,306 (DU PONT) discloses ABC block copolymer dispersants with a polymeric A segment of polymerized alkyl (meth)acrylate monomers having 1-12 carbon atoms in the alkyl group, aryl (meth)acrylate monomers, cycloalkyl (meth)acrylate monomers, a polymeric B segment of polymerized alkyl amino alkyl(meth)acrylate monomers with a quaternized alkyl group, and a polymeric C segment of polymerized hydroxyalkyl (meth)acrylate monomers.

The design of polymeric dispersants for inkjet inks is discussed in SPINELLI, Harry J. Polymeric Dispersants in Ink Jet Technology. Advanced Materials. 1998, vol. 10, no. 15, p. 1215-1218. Alternatively methods in which dispersion is achieved using a surfactant such as a water-soluble surfactant and/or a water-dispersible surfactant. Other methods include methods in which a hydrophilic functional group is introduced chemically and/or physically at the surface of the pigment particles, enabling the pigment to be dispersed and/or dissolved in water without using a dispersant or a surfactant. In embodiments of the present invention, a specific pigment dispersing resin described below is used as a method of dispersing the pigment using a pigment dispersing resin.

When using a pigment dispersing resin, the pigment and the pigment dispersing resin are preferably used in the form of a pigment dispersion obtained by dispersing the pigment and the pigment dispersing resin. Although there are no particular limitations on the method used for producing the pigment dispersion, one exemplary method is described below. First, the pigment is added to an aqueous medium prepared by mixing the pigment dispersing resin and water, and mixing and stirring are then performed. Then, by subjecting the thus obtained mixture to a dispersion treatment using a dispersion device, a pigment dispersion can be obtained. Subsequently, if required, a centrifugal separation treatment or filtration treatment may be performed. Any wet dispersion device may be used as the dispersion device, and of the various devices, the use of a beads mill is preferred.

Surfactant

The inkjet ink according to the present invention may contain at least one surfactant. The surfactant(s) can be anionic, cationic, non-ionic, or zwitter-ionic and are usually added in a total quantity less than 10 wt % based on the total weight of the pigmented inkjet ink and particularly in a total less than 5 wt % based on the total weight of the pigmented inkjet ink.

Suitable surfactants for the inkjet ink according to the present invention include silicon-based, acrylic-based and fluorine-based surfactants, fatty acid salts, ester salts of a higher alcohol, alkylbenzene sulphonate salts, sulphosuccinate ester salts and phosphate ester salts of a higher alcohol, ethylene oxide adducts of a higher alcohol, ethylene oxide adducts of an alkylphenol, ethylene oxide adducts of a polyhydric alcohol fatty acid ester, and acetylene glycol and ethylene oxide adducts thereof. Commercial examples include Byk-348, Byk-347, Byk 3450, Dynwet 800 (Byk Chemie Gmbh); Surfynol 104, Surfynol 465, Metolat 364, Dynol 800, Dynol 960, (Evonik Industries), KF-640, KF-642 (Shin-Etsu); ID-40, ID-70 (Sanyo Chemical industries); etc.

Humectants

The type of organic solvent is not particularly limited insofar as the effects of the present invention can be obtained. It is preferable that the organic solvent is water-soluble from the viewpoint of increasing the compatibility with respect to water. Examples of the water-soluble organic solvent include alcohols, polyhydric alcohols, amines, amides, glycol ethers, 1,2-alkanediols and the like. Only one type of the organic solvent may be used, or two or more types thereof may be used . . . . It should be noted that some humectants like diethylene glycol monobutyl ether, ethylene glycol monobutyl ether, ethylene glycol isopropylether, 1,2-hexanediolalso have surface tension active properties thereby lowering the surface tension of the ink.

Examples of alcohols described above include methanol, ethanol, propanol, isopropanol, butanol, isobutanol, secondary butanol, tertiary butanol, and the like.

Examples of polyhydric alcohols described above include ethylene glycol, diethylene glycol, triethylene glycol, tetraethylene glycol, polyethylene glycol having the number of ethylene oxide groups of greater than or equal to 5, propylene glycol, dipropylene glycol, tripropylene glycol, polypropylene glycol having the number of propylene oxide groups of greater than or equal to 4, butylene glycol, hexanediol, pentanediol, glycerin, hexanetriol, thiodiglycol, and the like. Examples of amines described above include ethanol amine, diethanol amine, triethanol amine, N-methyl diethanol amine, N-ethyl diethanol amine, morpholine, N-ethyl morpholine, ethylene diamine, diethylene diamine, triethylene tetramine, tetraethylene pentamine, polyethylene imine, pentamethyl diethylene triamine, tetramethyl propylene diamine, and the like.

Examples of amides described above include formamide, N,N-dimethyl formamide, N,N-dimethyl acetamide, and the like.

Examples of glycol ethers described above include ethylene glycol monoethyl ether, ethylene glycol monobutyl ether, diethylene glycol monoethyl ether, diethylene glycol monobutyl ether, triethylene glycol monobutyl ether, propylene glycol monopropyl ether, dipropylene glycol monomethyl ether, tripropylene glycol monomethyl ether, and the like.

Examples of 1,2-alkanediols 1,2-propanediol 1,2-butanediol, 1,2-pentanediol, 1,2-hexanediol, 1,2-heptanediol, and the like.

Among them, in a case where the organic solvent is polyhydric alcohols, blur at the time of performing printing at a high velocity can be preferably suppressed. Preferred examples of polyhydric alcohols include ethylene glycol, diethylene glycol, triethylene glycol, tetraethylene glycol, propylene glycol, dipropylene glycol, tripropylene glycol, and the like.

The content of the organic solvent in the printing ink, for example, can be in a range of greater than or equal to 5 wt % and less than or equal to 60 wt %.

Binder Resin

In one embodiment, the aqueous ink composition of the present invention preferably also contains a binder resin. Known binder resins for aqueous ink compositions include water-soluble resins and resin microparticles (emulsions/latexes). Examples of types of resins that can be used as the resin microparticles include acrylic-based, styrene/acrylic-based, urethane-based, styrene/butadiene-based, vinyl chloride-based and polyolefin-based resins.

Biocides

Suitable biocides for the pigmented inkjet ink of the present invention include sodium dehydroacetate, 2-phenoxyethanol, sodium benzoate, sodium pyridinethion-1-oxide, ethyl p-hydroxybenzoate, 2-methyl-1,2-thiazol-3-one and 1,2-benzisothiazolin-3-one and salts thereof. A biocide is preferably added in an amount of 0.001 to 3 wt %, more preferably 0.01 to 1.00 wt. %, each based on the total weight of the pigmented inkjet ink.

Other Components

In the ink jet printing ink, various known additives, for example, polysaccharides, a viscosity adjuster, a specific resistance adjuster, a film forming agent, an ultraviolet ray absorbent, an antioxidant, an anti-fading agent, an anti-mold agent, an antirust agent, a pH adjuster and the like can be suitably selected and used in addition to the components described above, as necessary, according to the object of improving all performances such as exiting stability, print head or ink cartridge adequateness, preservation stability, image preservability, and the like, and examples of the known additives are capable of including oil droplet fine particles such as liquid paraffin, dioctyl phthalate, tricresyl phosphate, and silicon oil, an ultraviolet ray absorbent described in JP 57-74193 A, JP 57-87988 A, and JP 62-261476 A, an antifading agent described in JP 57-74192 A, JP 57-87989 A, JP 60-72785 A, JP 61-146591 A, JP 1-95091 A, JP 3-13376 A, and the like, a fluorescent brightener described in JP 59-42993 A, JP 59-52689 A, JP 62-280069 A, JP 61-242871 A, JP 4-219266 A, and the like, such as optical brighteners, tracer molecules for security and counter fit, IR absorbing molecules for more enhancing drying or security purposes.

Preparation of a Pigmented Ink-Jet Ink

The pigmented ink-jet ink according to the present invention may be prepared by precipitating or milling the pigment in the dispersion medium in the presence of the dispersant or simply by mixing a self-dispersible color pigment in the ink (similar to the preparation of a dye-based ink-jet ink). Mixing apparatuses may include a pressure kneader, an open kneader, a planetary mixer, a dissolver, and a Dalton Universal Mixer. Suitable milling and dispersion apparatuses are a ball mill, a pearl mill, a colloid mill, a high-speed disperser, double rollers, a bead mill, a paint conditioner, and triple rollers. The dispersions may also be prepared using ultrasonic energy. Methods for preparation of very fine dispersions of pigments are disclosed in e.g. U.S. Pat. No. 5,679,138 (KODAK), U.S. Pat. No. 5,538,548 (BROTHER), U.S. Pat. No. 5,443,628 (VIDEOJET SYSTEMS), U.S. Pat. No. 4,836,852 (OLIVETTI), U.S. Pat. No. 5,285,064 (EXTREL), U.S. Pat. No. 5,184,148 (CANON) and U.S. Pat. No. 5,223,026 (XEROX). After milling is completed, the milling media is separated from the milled particulate product (in either a dry or liquid dispersion form) using conventional separation techniques, such as by filtration, sieving through a mesh screen, and the like. Often the sieve is built into the mill, e.g. for a bead mill. The milled pigment concentrate is preferably separated from the milling media by filtration.

In general it is desirable to make the color ink in the form of a concentrated mill grind, which is subsequently diluted to the appropriate concentration for use in the ink-jet printing system. This technique permits preparation of a greater quantity of pigmented ink from the equipment. If the mill grind was made in a solvent, it is diluted with water and optionally other solvents to the appropriate concentration. If it was made in water, it is diluted with either additional water or water miscible solvents to make a mill grind of the desired concentration. By dilution, the ink is adjusted to the desired viscosity, color, hue, saturation density, and print area coverage for the particular application.

The ink-jet inks are prepared by mixing the components with the dispersion using regular mixing devices. A method for the stirring and mixing is not particularly restricted and may be appropriately selected according to necessity, using a homogenizer, a paint shaker, an ultrasonic disperser, a stirrer using ordinary stirring blades, a magnetic stirrer, and a high-speed disperser, for example. The ink is finally filtered before use. With drop sizes less than 10 pl in many cases, and printhead nozzles smaller than 20 microns, filtration is implemented at less than one tenth of the nozzle size (2 microns), and in the case of dye-based inks significantly smaller than this. It is vital to ensure no particulates reach the nozzles, as a single failure can lead to the replacement of an entire printhead at significant cost.

With the wide variety of inkjet ink chemistries in use, several different filtration technologies need to be used to give optimum results. For a typical dye-based ink, multiple stages of filtration are used after mixing of the colorant with the carrier, and again after addition of additives and dilution. The objectives are to remove any insoluble elements, particles, environmental contaminants and biological materials. The filter choice is critical, especially where multi-stage filtration is used. For pigmented inks, multiple-stage filtration is typically used after creation of the dispersion, and again after addition of additives and dilution. Here the main objectives are removal of any oversized or agglomerated pigments from the dispersion, as well as any oversized particles and contaminants from other processes.

The available filter technologies have different applications, advantages and disadvantages. Examples of filter are: membrane, depth and hybrid filter types. Common suppliers of filters for inkjet inks are Pall, Porvair, Membrane Solutions.

Preparation of the Primer Solution

The primer is manufactured by dissolving all water-soluble components, and adding any other components, in an aqueous medium and further by stirring and mixing according to necessity. A method for the stirring and mixing is not particularly restricted and may be appropriately selected according to necessity, using a homogenizer, a paint shaker, an ultrasonic disperser, a stirrer using ordinary stirring blades, a magnetic stirrer, and a high-speed disperser, for example.

Coated Substrate

Coated substrates are generally known to have poor receptivity to aqueous ink-jet inks compared to uncoated papers. These coated substrates or coated papers may have low surface porosity due to calendaring and/or application of one or more layers of hydrophobic coating layers. The resultant low porosity means less channels for the ink vehicle to access which results in a greater dependency on ink drying by evaporation. Furthermore, a hydrophobic nature of the coating layers causes reduced wetting out and spreading out of aqueous inks upon printing which can then lead to puddling of ink drops on the media surface. The combined effect of less dot spread and slower drying leads to many more image defects when printing aqueous inks directly on coated substrates.

Print Process/Printing Method:

The print process uses a primer application step, followed by an ink-jet printing step. The primer application can be done inline or offline in an analogue way using a roller, flexo plate, offset plate, curtain coating and alike but can also be done in a digital way using ink-jet printheads, either piezo or ink-jet and perhaps even piston based ink-jet, commercially available from Valvejet. The ink-jet step can be carried out using any kind of printhead: thermal, piezo, continuous ink-jet. The use of Valvejet-like printheads is less likely for the image generation. In between these (at least 2) steps (primer application step, followed by a ink-jet printing step), one or more drying steps can be incorporated. The primer step and ink-jet printing step can be followed by another ink-jet printing step immediately but also a new primer step and ink jet printing step can be used. The invention is not limited to a certain setup or certain drying means as long as the primer application step is followed by an ink-jet printing step. The drying means can be of any relevant kind to the used ink-jet ink technology or primer technology. It can be heat-based (hot air, infrared, near-infra-red or combinations thereof) or actinic radiation-based and the drying intensity or capacity does not have to be the same for the primer composition and the ink-jet ink. The printed product can be dried using an additional final drying step of any kind and intensity as well.

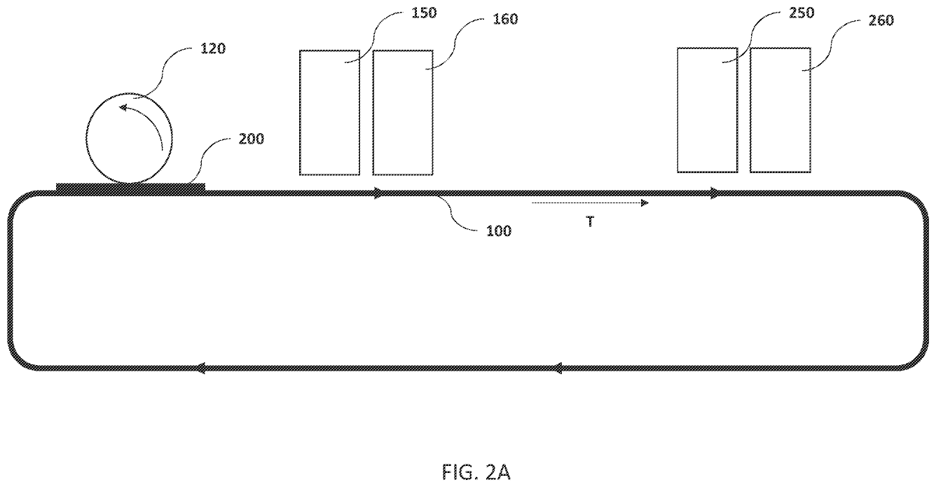

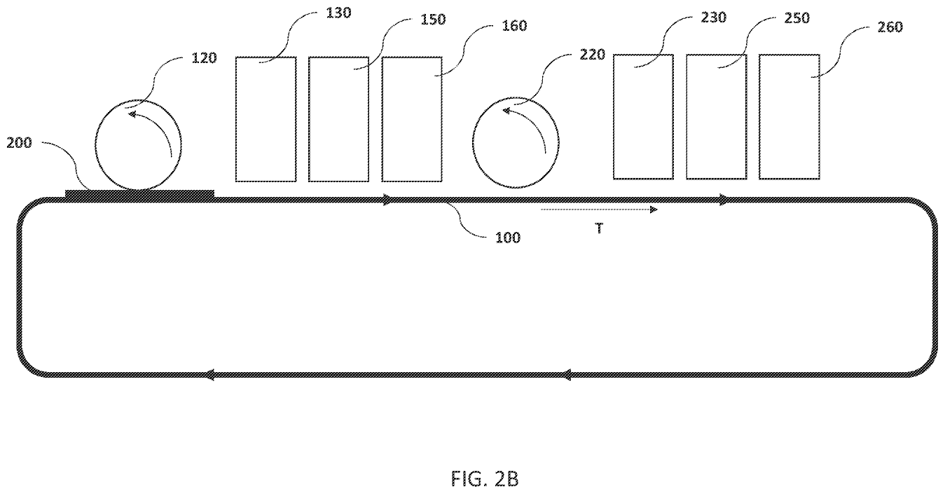

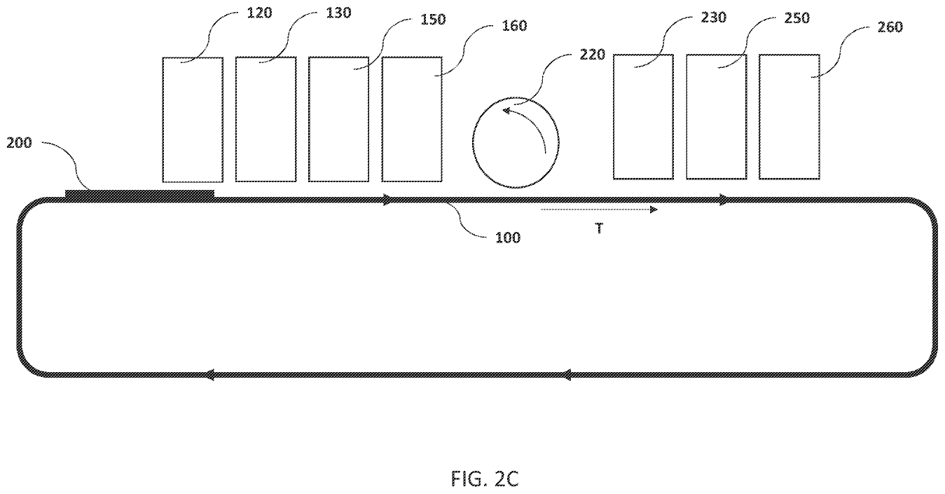

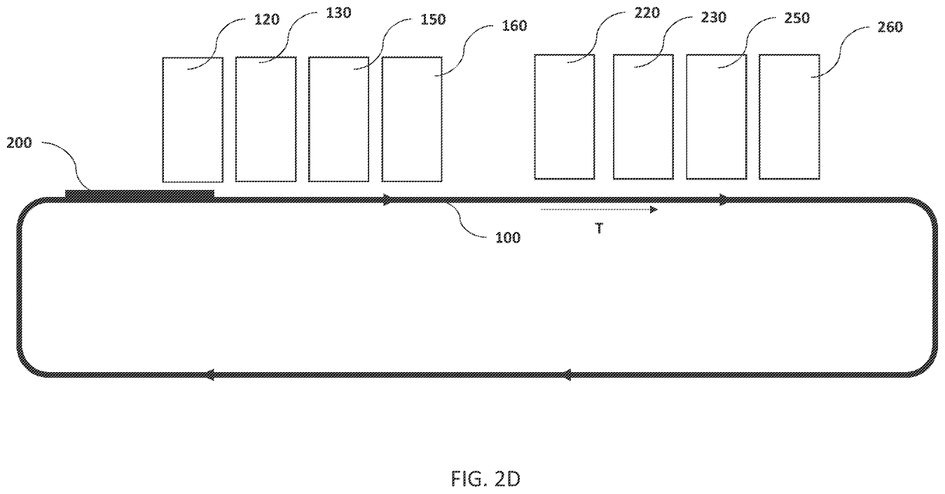

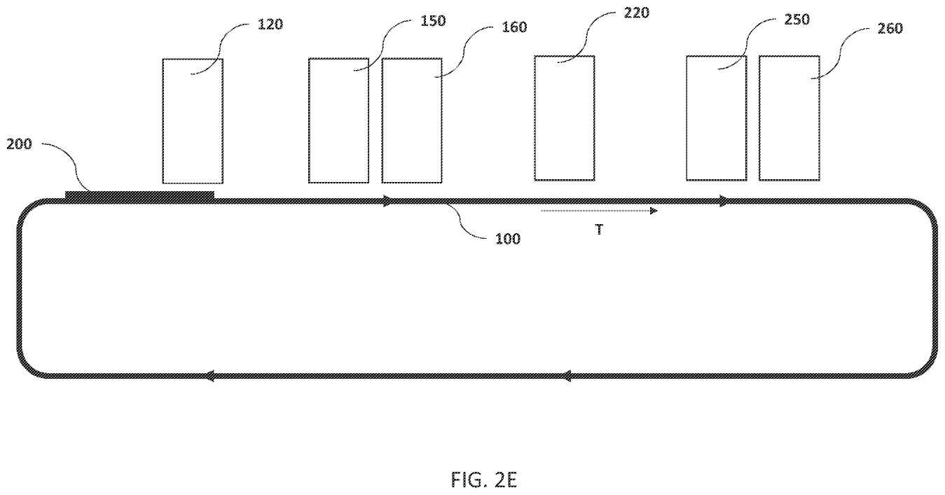

FIGS. 2A-2E show a number of options for the printing method, but the invention is not limited to these options.

FIG. 2A shows schematically a printing apparatus according to a first embodiment comprising a transport belt 100 for moving a coated substrate 200, a primer application station 120, a first print head station 150, a first dryer station 160, a second print head station 250 and a second dryer station 260. The transport belt 100 is configured to move the coated substrate 200 consecutively along the primer application station 120, the first print head station 150, the first dryer station 160, the second print head station 250 and the second dryer station 260. The primer application station 120 applies a primer composition onto the coated substrate 200. The primer composition may be dry or may still be wet when the coated substrate 200 arrives at the first print head station 150. The first print head station 150 applies inkjet droplets of a first ink onto the substrate in a print resolution and a droplets size according to the invention. The first dryer station 160 dries the coated substrate including the first ink. The second print head station 250 applies inkjet droplets of a second ink onto the substrate in a print resolution and a droplets size according to the invention. The second dryer station 260 dries the coated substrate including the image of the first ink and the second ink.

Optionally, the coated substrate is pre-heated prior to the primer application step in an inline or offline method.

Optionally, the first print head station 150 may apply inkjet droplets of a first ink and a second ink, such as Cyan and Magenta, onto the substrate in a print resolution and a droplets size according to the invention and the second print head station 250 may apply inkjet droplets of a third ink and a fourth ink, such as Yellow and Black, onto the substrate in a print resolution and a droplets size according to the invention.

Additionally, the printing apparatus may comprise additional print head stations for printing further inks on the coated substrate 200 and drying stations for drying the additional inks on the coated substrate 200. In a preferred example the setup as described in FIG. 2A further holds a third print head station and dryer station and a fourth print head station and dryer station. In a more preferred example each print head station holds more than one print head printing the same color (eventually in staggered configuration to allow seamless stitching). In a most preferred example the color printing order of the inkjet inks after the primer application is yellow, followed by cyan, followed by magenta, followed by black.

FIG. 2B shows schematically a printing apparatus according to a second embodiment comprising a transport belt 100 for moving a coated substrate 200, a first primer application station 120, a first primer dryer station 130, a first print head station 150, a first dryer station 160, a second primer application station 220, a second primer dryer station 230, a second print head station 250 and a second dryer station 260. The transport belt 100 is configured to move the coated substrate 200 consecutively along the first primer application station 120, the first primer dryer station 130, the first print head station 150, the first dryer station 160, the second primer application station 220, the second primer dryer station 230, the second print head station 250 and the second dryer station 260. The first primer application station 120 and the second primer application station 220 is in the form of a roller assembly. In this embodiment, the first primer application station 120 applies a primer composition onto the coated substrate upstream of the first print head station 150. In a next step, the primer composition is dried on the coated substrate by the primer dryer station 130. The second primer application station 220 applies a, fresh, primer composition onto the coated substrate upstream of the second print head station 250. In a next step, the primer composition is dried on the coated substrate by the second primer dryer station 230. The primer compositions applied by the primer application stations 120, 220 may be the same and may be different.

FIG. 2C shows schematically a printing apparatus according to a third embodiment comprising a transport belt 100 for moving a coated substrate 200, a first primer application station 120, a first primer dryer station 130, a first print head station 150, a first dryer station 160, a second primer application station 220, a second primer dryer station 230, a second print head station 250 and a second dryer station 260. The transport belt 100 is configured to move the coated substrate 200 consecutively along the first primer application station 120, the first primer dryer station 130, the first print head station 150, the first dryer station 160, the second primer application station 220, the second primer dryer station 230, the second print head station 250 and the second dryer station 260. The first primer application station 120 is in the form of a print head, such as a piston based ink-jet print head. The second primer application station 220 is in the form of a roller assembly.

The primer compositions applied by the primer application stations 120, 220 may be the same and may be different. In an example, the primer composition applied by the first application stations 120 may have a lower viscosity then the primer composition applied by the second application stations 120. Additionally, the print head 120 may apply the primer composition uniformly onto the coated substrate or may apply the primer composition locally onto the substrate, such as according to a digital image.

FIG. 2D shows schematically a printing apparatus according to a fourth embodiment comprising a belt 100 for moving a coated substrate 200, a first primer application station 120, a first primer dryer station 130, a first print head station 150, a first dryer station 160, a second primer application station 220, a second primer dryer station 230, a second print head station 250 and a second dryer station 260. The transport belt 100 is configured to move the coated substrate 200 consecutively along the first primer application station 120, the first primer dryer station 130, the first print head station 150, the first dryer station 160, the second primer application station 220, the second primer dryer station 230, the second print head station 250 and the second dryer station 260. The first primer application station 120 and the second primer application station 220 is in the form of a print head respectively, such as a piston based ink-jet print head. The print heads 120, 220 may apply the primer composition uniformly onto the coated substrate or may apply the primer composition locally onto the substrate, such as according to a digital image. In this embodiment, active drying of the primer composition on the coated substrate is performed between the step of applying the primer composition and the step of depositing the inkjet droplets.

FIG. 2E shows schematically a printing apparatus according to a fifth embodiment comprising a belt 100 for moving a coated substrate 200, a first primer application station 120, a first print head station 150, a first dryer station 160, a second primer application station 220, a second print head station 250 and a second dryer station 260. The transport belt 100 is configured to move the coated substrate 200 consecutively along the first primer application station 120, the first print head station 150, the first dryer station 160, the second primer application station 220, the second print head station 250 and the second dryer station 260. The first primer application station 120 and the second primer application station 220 is in the form of a print head respectively, such as a piston based ink-jet print head. In this embodiment, no active drying of the primer composition on the coated substrate is performed between the step of applying the primer composition and the step of depositing the inkjet droplets.

A print station may have a “print head resolution”, which is perpendicular to the substrate transport direction. The print station may comprise a single print head having a length of at least the width of said desired printing range. The print station may also be constructed by combining two or more inkjet heads, such that the combined lengths of the individual inkjet heads cover the entire width of the printing range. Additionally or alternatively, print heads may also be arranged in a staggered arrangement having a first row of print heads and a second row of print heads, which are arranged staggered with respect to the print heads of the first row. Such a staggered arrangement of print heads is generally known in the art. The staggered arrangement provides a page wide array of nozzles which are substantially equidistant in the length direction of the print head station (perpendicular to the substrate transport direction T). The staggered arrangement may provide a redundancy of nozzles in the area where the inkjet heads of the first row and the second row overlap. Staggering may further be used to decrease the nozzle pitch (hence increasing the “print head resolution”) in the length direction of the print station, e.g. by arranging the second row of inkjet heads such that the positions of the nozzles of the inkjet heads of the second row are shifted in the length direction of the inkjet marking device by half the nozzle pitch, the nozzle pitch being the distance between adjacent nozzles in an inkjet head, The “print head resolution” of the print station may be further increased by using more rows of inkjet heads, each of which are arranged such that the positions of the nozzles of each row are shifted in the length direction with respect to the positions of the nozzles of all other rows.

Measuring Methods

Liquid Absorption

The absorption rate of the coated substrate is measured by placing a 2 ml droplet of reference liquid on the substrate that is placed under an angle of 60° with respect to a horizontal plane. The absorption rate measurement is performed at a temperature between 20° C. and 25° C. and a relative humidity of 30-50%. The reference liquid composition resembles an ink without pigments and is very low viscous (20 wt % glycerol/10 wt % 1,2-propanediol/3 wt % diethylene glycol monobutyl ether/0.13 wt % Surfynol 104 H-rest is water). Under gravitational force the droplet runs down the paper but meanwhile the liquid is being absorbed, and the time to travel a certain distance is recorded. The longer the travel distance the less will be the absorption of the ink into the substrate. The drop travel distance is determined between the location of placing the droplet and the location after a certain time and is measured in cm. The measuring time is typically 50 seconds after placing the droplet.

Contact Angle Measurement

By the contact angle measurement the wettability of the inks on the substrates can be measured. The contact angle measurement was performed at a temperature between 20° C. and 25° C. and a relative humidity between 30%-50%. The contact angle was measured by putting a 3 μl liquid ink droplet on the substrate. The droplet is placed on the substrate using a micro syringe and a high speed resolution camera records the contour of the spreading droplet (OCA 25, DataPhysics Instruments GmbH, Filderstadt GE). The contact angle reaches a steady state value 2 seconds after the droplet releases from the syringe and makes first contact with the substrate. The average contact angle was calculated from the three measurements.

Surface Tension

The surface tension is a value measured at a temperature between 23.0° C. and 26.0° C. by the air bubble pressure method using a surface tensiometer SITA Pro Line T15 (SITA Messtechnik Co, Dresden GE.). The bubble lifetime used is 10 seconds and this is the time between the generation of a new air-liquid interface (at the tip of a capillary immersed into the ink liquid) until the maximum bubble pressure is reached. The maximum pressure measured is automatically recalculated into a surface tension value of the liquid (in mN/m) after calibration of the device in distilled water.

Evaluation of Image Quality

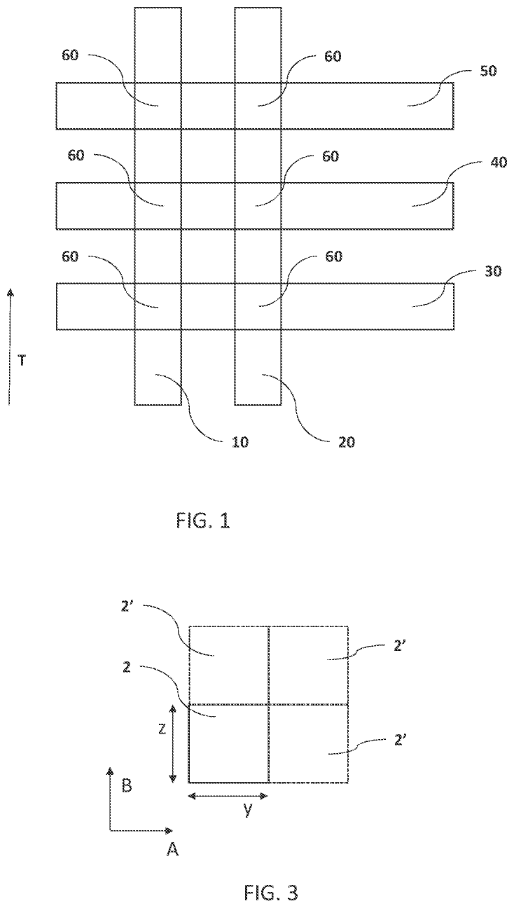

FIG. 1 illustrates schematically a test chart to test image quality. The test chart comprises two yellow areas 110 and 130. The yellow areas 100, 110 are rectangular and have their longest dimension along the substrate transport direction T. The test chart comprises three cyan areas 210, 220, 230. The cyan areas 210, 220, 230 are rectangular and have their longest dimension perpendicular to the substrate transport direction T. In the overlay areas 300, a yellow area and a cyan have overlap.

After printing the image of FIG. 1 the overlay area 300 of cyan and yellow was evaluated for bleeding by visual inspection.

1: no to almost no visible bleeding

2: acceptable bleeding

3: non acceptable bleeding

Evaluation of Stripes

After printing the image of FIG. 1 the cyan areas 210, 220, 230 (outside the overlay area 300) was evaluated for stripes by visual inspection.

1: no to almost no visible stripes

2: acceptable level of stripes

3: non acceptable level of stripes

4: highly disturbing level of stripes

### Examples

Water based inks C1-C5 were prepared by mixing the ingredients as mentioned in Table 1 for 30 minutes. The amounts in Table 1 are weight % of the total weight of the water based ink. The amount of water is added to add up to 100 weight % in total. Afterwards the inks were filtered over a 1 μm filter. The viscosity of the inks is about 6 mPa·s, which is within the specification of the Kyocera KJ4BYH 600 dpi and Fuji Samba G3L 1200 dpi head.

TABLE 1

| [wt %] | C1 | C2 | C3 | C4 | C5 |
|---|---|---|---|---|---|
| Cyan Pigment dispersion APD1000 | 21 | 21 | 21 | 21 | 21 |
| Glycerol | 20 | 20 | 20 | 20 | 17 |
| Propane diol | 10 | 10 | 10 | 10 | 8 |
| diethyleneglycol monobutylether | 3 | 3 | 3 | 3 | 3 |
| Surfynol 104 | 0.2 | 0.2 | 0.2 | 0.1 | — |
| Byk 348 | 0.1 | 0.4 | — | 0.05 | — |
| Metolat 364 | — | — | 1.5 | — | — |
| Surfynol 465 | — | — | — | — | 0.95 |
| Dynol 960 | — | — | — | — | 1.8 |
| Joncryl J8050E | — | — | — | — | 7.5 |
| water | rest | rest | rest | rest | rest |

APD1000: pigment dispersion with 14% pigment concentration available from Fujifilm;
Surfynol 104 available from Evonik Industries (acetylene diol based surfactant);
Surfynol 465 available from Evonik Industries;
Byk 348 available from Byk additives (a polyether modified polysiloxane surfactant);
Metoloat 364 available from Munzing (nonionic surfactant);
Dynol 960 available from Evonik Industries;
Joncryl J8050E available from BASF;
Yellow inks Y1, Y2, Y3, Y4, Y5 were prepared with the same composition to the corresponding C1, C2, C3, C4 and C5 inks but with APD1000 yellow dispersion from Fujifilm

The physical properties of the inks are summarized in table 2

TABLE 2

| | C1 | C2 | C3 | C4 | C5 |
|---|---|---|---|---|---|
| Contact angle (°) on substrate 1 | 23.5 | 21.2 | 16.0 | 26.6 | 9 |
| Contact angle (°) on substrate 2 | 19.0 | 15.0 | 7.0 | 21.5 | 3 |
| Static surface tension mN/m | 27.0 | 24.0 | 26.5 | 30.7 | 24 |

Substrate 1: Metsaboard pro WKL 135 gsm coated substrate from Metsaboard
Substrate 2: Sappi Fusion 135 gsm coated substrate from Sappi

From the Table it is clear that the contact angle on both substrates 1 and 2 are improved going from C1 to C3. At the same time, the static surface tension does not show a clear trend which correlates with the contact angle on the substrates. Ink C5 has a low contact angle both on substrate 1 and 2, which is much lower compared to the inks C1-C4. This demonstrates that ink C5 has a high wetting behavior.

The absorption characteristic of both substrates was tested according to the drop travel distance test. Absorption characteristic of both substrate are mentioned in Table 3.

TABLE 3

| | Traveling distance cm | Traveling distance cm |
|---|---|---|
| | after 25 sec | after 50 sec |
| | [cm] | [cm] |
| Substrate 1 | 15.0 | 17.0 |
| Substrate 2 | 14.0 | 18.0 |
| Substrate 3 | 6.0 | 6.0 |

Substrate 3; Metsaboard bright 135 gsm uncoated substrate from Metsaboard

From table 3 it is clear that the uncoated substrate absorbs much faster the reference liquid.

The inks were evaluated on an ink-jet testrig equipped with a belt to transport the substrate.

The belt and thus the printing speed was set at 1 m/s. The ink was loaded onto a Kyocera KJ4B YH printhead of 600 dpi available from Kyocera and purged and wiped until no failing nozzles were present anymore. FIG. 1 was printed with a printing distance of 2.5 mm and evaluated for bleeding and stripes.
Substrate 1
Substrate 2
Substrate 1 with primer
Substrate 2 with primer

The primer solutions are prepared according to Table 4, wherein for primer solution P1 citric acid is the active coagulating agent, which is used together with the other ingredients listed in the table below. For primer solution P2 a multivalent metal ion compound Dialuminum chloride pentahydroxide is the active coagulating agent, which is used together with the other ingredients listed in the table below. For primer solution P3 the cationic polymer Poly(diallyldimethylammonium chloride) having a Mw100.000 g/mol is the active coagulating agent, which is used together with the other ingredients listed in the table below.

Furthermore distilled water is added to reach 100 wt % and finally the solution is stirred for at least 30 minutes at room temperature conditions.

TABLE 4

| | Primer | | |
|---|---|---|---|
| | P1 | P2 | P3 |
| Component | wt % | wt % | wt % |
| Citric acid | 10% | — | — |
| Dialuminum chloride pentahydroxide | — | 5% | — |
| Poly(diallyldimethylammonium | — | — | 5% |
| chloride) Mw100.000 g/mol | | | |
| Glycerol | 15% | 15% | 15% |
| Surfynol 104H | 0.2% | 0.2% | 0.2% |
| Byk-348 | 0.4% | 0.4% | 0.4% |

Top liner paper sheets, typically used for producing corrugated sheets, were treated with the primer solution using an automated wire bar coating device. The type of wire bar (type Elcometer 4360/4361) and the coating speed was selected to achieve a wet coating weight of 10 μm. Afterwards, the coated sheet was dried in a vented oven for 2 minutes at 100° C. to ensure that all water was evaporated. Finally, the treated liners are acclimatized for minimally 10 minutes before ink-jet printing.

The procedure was repeated with a Samba G3L printhead of 1200 dpi available from Fujifilm Dimatix.

The print resolution in the direction perpendicular to the substrate transport direction is determined by the distance between the nozzles of the printhead in this direction. The print resolution in the substrate transport direction is selected equal to the print resolution of the printhead in the direction perpendicular to the substrate transport direction.

The conditions for testing and the results are summarized in Table 5.

TABLE 5

| | | | resolution | resolution | dropsize | dropsize | | no primer | | primer | |
|---|---|---|---|---|---|---|---|---|---|---|---|
| example | ink | substrate | (dpi) | (μm) (y) | (pl) | (μm) (x) | ratio | stripes | bleeding | stripes | bleeding |
| com 1 | C3/Y3 | 1 | 600 | 42 | 7 | 23.7 | 0.56 | 3 | 1 | 3 | 1 |
| com 2 | C3/Y3 | 2 | 600 | 42 | 7 | 23.7 | 0.56 | 3 | 1 | 3 | 1 |
| ex 1 | C3/Y3 | 2 | 600 | 42 | 12 | 28 | 0.67 | 2 | 3 | 2 | 1 |
| ex 2 | C3/Y3 | 1 | 600 | 42 | 18 | 32 | 0.76 | 1 | 3 | 1 | 1 |
| ex 3 | C3/Y3 | 2 | 600 | 42 | 18 | 32 | 0.76 | 1 | 3 | 1 | 1 |
| ex 4 | C3/Y3 | 1 | 1200 | 21 | 2.4 | 16 | 0.76 | 1 | 3 | 2 | 1 |
| ex 5 | C3/Y3 | 1 | 1200 | 21 | 5.9 | 22.4 | 1.07 | 1 | 3 | 1 | 1 |
| ex 6 | C3/Y3 | 1 | 1200 | 21 | 13 | 29.1 | 1.38 | 1 | 3 | 1 | 2 |
| com 3 | C2/Y2 | 2 | 600 | 42 | 7 | 23.7 | 0.56 | 3 | 1 | 3 | 1 |
| com 4 | C2/Y2 | 1 | 600 | 42 | 7 | 23.7 | 0.56 | 3 | 1 | 3 | 1 |
| ex 7 | C2/Y2 | 1 | 600 | 42 | 18 | 32 | 0.76 | 2 | 3 | 2 | 1 |
| ex 8 | C2/Y2 | 2 | 600 | 42 | 18 | 32 | 0.76 | 1 | 3 | 1 | 1 |
| ex 9 | C1/Y1 | 1 | 600 | 42 | 18 | 32 | 0.76 | 2 | 3 | 2 | 1 |
| ex 10 | C1/Y1 | 1 | 1200 | 21 | 5.9 | 22.4 | 1.07 | 1 | 3 | 1 | 1 |
| ex 11 | C1/Y1 | 1 | 1200 | 21 | 13 | 29.1 | 1.38 | 1 | 3 | 1 | 2 |
| com 5 | C4/Y4 | 1 | 600 | 42 | 7 | 23.7 | 0.56 | 3 | 1 | 4 | 1 |
| ex 12 | C5/Y5 | 1 | 600 | 42 | 18 | 32 | 0.76 | 1 | 3 | 1 | 1 |
| ex 13 | C5/Y5 | 2 | 600 | 42 | 18 | 32 | 0.76 | 1 | 3 | 1 | 2 |
| ex 14 | C5/Y5 | 1 | 600 | 42 | 18 | 32 | 0.76 | 1 | 3 | 2 | 1 |
| ex 15 | C5/Y5 | 2 | 600 | 42 | 18 | 32 | 0.76 | 1 | 3 | 1 | 1 |
| ex 16 | C5/Y5 | 1 | 600 | 42 | 18 | 32 | 0.76 | 1 | 3 | 2 | 1 |
| ex 17 | C5/Y5 | 2 | 600 | 42 | 18 | 32 | 0.76 | 1 | 3 | 1 | 2 |
| ex 18 | C3/Y3 | 1 | 600 | 42 | 18 | 32 | 0.76 | 1 | 3 | 2 | 1 |
| com 6 | C5/Y5 | 2 | 600 | 42 | 7 | 23.7 | 0.56 | 3 | 2 | 3 | 1 |

In experiments 1-13 and comparison experiments (com 1-6), the primer composition used for the primer experiments is P1 (composition as shown in Table 4).

In experiments 14-15 and 18, the primer composition used for the primer experiments is P2 (composition as shown in Table 4).

In experiments 16-17, the primer composition used for the primer experiments is P3 (composition as shown in Table 4).

The Ratio R in this table is defined by the drop size (micron) (x)/resolution print head (micron) (y).

From the table it is clear that when the ratio R is too low stripes occur (com 1 to com 4). Even when inks are adapted to increase their wetting properties (see com1 and com 2 having C3/Y3) and when selecting a substrate having a lower contact angle (com 3 and com 2) stripes occur.

From com 5 it is clear that when an ink with low wetting properties is used the stripe level further increases when a primer is applied.

Ex 1 to ex 6 illustrate that by increasing the ratio R the stripes level improves but at the same time bleeding occurs. In particular, Ex 1 and Ex 7 and Ex 9 show that white stripes and bleeding occur at the same.

The Ex 1 to ex 6 further illustrate that when combining the higher ratio R with applying a primer (P1) on the substrate, the bleeding can be reduced without recurring problems of white stripes.

Ex 7 to ex 11 shows that for inks with lower wetting properties the stripe level is acceptable if the Ratio R>0.6 but already some bleeding is noticed. The bleeding can be overcome by applying a primer (P1).

Ex 12 and 13 demonstrate that also with a high wettable ink C5, by combining the higher ratio R (>0.60) with applying a primer (P1) on the substrate, the bleeding can be reduced by using the primer (P1) without recurring problems of white stripes. At the same time, the comparison example 6 shows that a ratio R below 0.60 leads to stripes regardless of using the primer (even when the ink C5 is adapted to have high wetting properties and selecting a substrate 2 having a low contact angle).

Thus, the beneficial results of the ratio x/y>0.60 are shown by the experiments 1-4, experiments 7-9 and experiments 12-13 to be substantially independent of the ink composition and wetting behavior of the ink.

Ex 1 to Ex 4 show compared to Ex 7 to Ex 9 that for inks with improved wetting properties (C3/Y3) the stripe level is further improved at the ratio >0.7.

Ex 14 and 15 demonstrate that the beneficial results shown in Ex 12 and 13 for primer composition

P1 is also obtained when using a primer composition P2 (having a multivalent metal ion compound as coagulating agent). Furthermore, Ex 16 and 17 demonstrate that the beneficial results are also obtained when using a primer composition P3 (having a cationic polymer compound as coagulating agent).

In addition, Ex 18 demonstrates that the beneficial result shown in Ex 2 is also obtained when using a primer composition P2 (having a multivalent ion compound as coagulating agent) instead of primer composition P1.

Thus, the beneficial results of the ratio x/y>0.60 are shown by these experiments 12-18 to be independent of the primer composition and in particular on the coagulating agent.

It should be appreciated by those skilled in the art that any block diagrams herein represent conceptual views of illustrative units or modules embodying the principles of the invention. Whilst the principles of the invention have been set out above in connection with specific embodiments, it is to be understood that this description is merely made by way of example and not as a limitation of the scope of protection which is determined by the appended claims.

1. A printing method,
applying a primer composition, which comprises at least one pigment aggregating agent, to a coated substrate prior to an ink-jet printing step,
wherein the ink-jet printing step is performed using inkjet droplets having x μm drop diameter, printed in a print resolution on the coated substrate that corresponds to a rectangular unit cell having cell dimensions of y μm by z μm, and
wherein the ratio of x/y is >0.60.

2. The method of claim 1, wherein the primer composition is a water-based primer composition.

3. The method of claim 1, wherein the pigment aggregating agent is selected from the group consisting of an ionic polymer, a multivalent metal salt, an acid, and mixtures thereof.

4. The method of claim 1, wherein the ink-jet printing process uses pigmented aqueous ink-jet inks.

5. The method of claim 1, wherein the coated substrate has an absorption rate defined by a drop travel distance larger than 10.0 cm, wherein the drop travel distance is defined by the distance travelled by a 2 ml drop of a reference liquid at 50 seconds after being placed on the substrate and wherein the substrate is placed under an angle of 60° with respect to a horizontal plane.

6. The method of claim 1, wherein the ink of the ink-jet droplets has a static contact angle on the coated substrate lower than 26.

7. The method of claim 6, wherein the ink of the ink-jet droplets has a static contact angle on various coated substrates lower than 26°.

8. The method of claim 1, wherein the ink of the ink-jet droplets has a static surface tension lower than 32 mN/m.

9. The method of claim 4, wherein the pigments used in the ink-jet inks are dispersed using encapsulated dispersion technology.

10. The method of claim 4, wherein the pigments used in the ink-jet inks are dispersed using a block co-polymer dispersant.

11. The method of claim 1, wherein the y dimension is perpendicular to a substrate transport direction.

12. The method of claim 1, wherein a ratio z/y is between 0.5 and 2.0, and wherein z is arranged orthogonal to y.

13. The method of claim 1, wherein the coated substrate is a liner suitable to produce corrugated boards.

14. The method of claim 13, wherein the ink droplets are printed after producing the corrugated board.

15. The method of claim 1, wherein a jetting distance of the ink droplets is >2 mm.

16. The method of claim 1, wherein the inkjet printing step is carried out at a substrate transport velocity of at least 0.5 m/s.

17. The method of claim 1, wherein the inkjet printing step is carried out using a single pass of the substrate.

18. The method of claim 1, wherein the method comprises a thermal drying step of the coated substrate before, during or after the printing of the ink droplets on the coated substrate.

19. The method of claim 1, wherein the inkjet printing method uses piezo-operated print heads.

20. The method of claim 1, wherein the inkjet printing step comprises printing at least 4 inkjet printing colors comprising cyan, magenta, yellow and black; and wherein after each printed color a thermal drying step is performed.

21. (canceled)
